(19) United States
(12) Patent Application Publication
(10) Pub. No.: US 2008/0018947 A1
(43) Pub. Date: Jan. 24, 2008

(54) Image forming apparatus

(75) Inventor: Mikimasa Honma, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/822,973

(22) Filed: Jul. 11, 2007

(30) Foreign Application Priority Data
Jul. 18, 2006 (JP) 2006-195637

(51) Int. Cl. H04N 1/00

(52) U.S. Cl. 358/401

(57) ABSTRACT

Disclosed is an image forming apparatus including an image reading section to read image from a document; a display section to display a reduced image of the image read by the image reading section; an image output section to output the image read by the image reading section on a transfer paper; and a control section to make the display section display at least a part of a sequential operation which starts from image reading and ends in image output, by a moving image that uses the reduced image.

### CROSS-REFERENCE TO RELATED APPLICATIONS

The present U.S. patent application claims a priority under the Paris Convention of Japanese patent application No. 2006-195637 filed on Jul. 18, 2006, which shall be a basis of correction of an incorrect translation.

### BACKGROUND OF THE INVENTION

1. Field of the Invention

The present invention relates to an image forming apparatus.

2. Description of Related Art

Conventionally, a technique to display a reduced image and the like of an image which is read from a document in a display section, has been known. For example, with respect to a case where a plurality of documents are read sequentially and images that have been read are accumulated, a technique to display reduced images of the accumulated images has been proposed (For example, refer to Japanese Patent Application Publication No. 2003-333245.). In addition, a technique to provide a program to display a file icon has been proposed (For example, refer to Japanese Patent Application Publication No. 2004-54839.).

However, the afore-mentioned related arts lacked a function to display an operation relating to image reading, in a manner so that the operation is easily recognized by a user visually. Here, the “operation relating to image reading” is a reading operation performed by an applied image reading function and a reading operation performed in accordance with an image reading condition which is set. The “reading operation performed by the applied image reading function” is a reading operation performed by a function to read both sides of a document, a reading operation performed by a function to read document pages successively, and a reading operation performed by a function to read a document and apply a stamp on the read image. The “reading operation performed in accordance with the image reading condition which is set” is a reading operation which is conducted in accordance with a setting to automatically delete portions in the document that is outside a selected transfer paper size, and to conduct reading only within the selected transfer paper size.

For example, in a case where a user selected a function to read both sides of the document, the user could not confirm a procedure in which the read images were stored in a recording medium, when the reduced image was displayed in the display section. Therefore, the user could not confirm whether the intended image reading was conducted or not.

In a similar manner, in a case where the read image was output to the transfer paper, the user could not confirm a procedure in which the read image was output to the transfer paper, when the image was being output. Therefore, the user could not confirm whether the intended image output was conducted or not.

### SUMMARY

An object of the present invention is to provide an image forming apparatus which is capable of allowing a user to confirm that at least a part of a sequential operation intended by the user, the sequential operation starting from image reading and ending in output of the image, is conducted.

To achieve at least one of the abovementioned objects, an image forming apparatus reflecting one aspect of the present invention comprises

an image reading section to read image from a document;

a display section to display a reduced image of the image read by the image reading section;

an image output section to output the image read by the image reading section on a transfer paper; and

a control section to make the display section display at least a part of a sequential operation which starts from image reading and ends in image output, by a moving image that uses the reduced image.

Preferably, the image forming apparatus further comprises

a non-volatile storing section;

wherein the moving image that uses the reduced image includes a moving image showing that the image read by the image reading section is stored in the storing section.

Preferably, with respect to the image forming apparatus, the reduced image uses a thumbnail image.

Preferably, with respect to the image forming apparatus, the moving image that uses the reduced image includes at least a moving image showing one of both-sides reading of the document, successive page reading of the document, document reading and stamping, and transfer paper reading.

Preferably, with respect to the image forming apparatus, the control section synchronizes an operation to display the both-sides reading of the document by the moving image using the reduced image, and an operation of image reading by the image reading section.

### BRIEF DESCRIPTION OF THE DRAWINGS

The present invention will become more fully understood from the detailed description given hereinafter and the accompanying drawings which are given by way of illustration only, and thus are not intended as a definition of the limits of the scope of the invention, and wherein:

FIG. 1 is a view showing an internal block diagram of an image forming apparatus 1 according to the present invention;

FIG. 2A is a view showing that a mount paper for thumbnail, a thumbnail image of front side, and a picture of a HDD are displayed;

FIG. 2B is a view showing that the thumbnail image of front side moves to another location;

FIG. 2C is a view showing that the thumbnail image of front side moves to another location;

FIG. 2D is a view showing that the thumbnail image of front side overlaps with the picture of the HDD;

FIG. 2E is a view showing that the mount paper for thumbnail is being turned over;

FIG. 2F is a view showing that the mount paper for thumbnail is being turned over;

FIG. 2G is a view showing that the mount paper for thumbnail is being turned over;

FIG. 2H is a view showing that a thumbnail image of back side is displayed on the mount paper for thumbnail which is turned upside down;

FIG. 3A is a flowchart showing a both-sides reading processing;

FIG. 3B is a flowchart showing a both-sides reading processing which continues from FIG. 3A;

FIG. 4A is a flowchart showing a display operation of the display section, an internal processing operation of a CPU, and an actual equipment operation of the image forming apparatus, when the both-sides reading processing is conducted;

FIG. 4B is a flowchart showing a display operation of the display section, an internal processing operation of a CPU, and an actual equipment operation of the image forming apparatus, when the both-sides reading processing is conducted, which continues from FIG. 4A;

FIG. 4C is a flowchart showing a display operation of the display section, an internal processing operation of a CPU, and an actual equipment operation of the image forming apparatus, when the both-sides reading processing is conducted, which continues from FIG. 4B;

FIG. 4D is a flowchart showing a display operation of the display section, an internal processing operation of a CPU, and an actual equipment operation of the image forming apparatus, when the both-sides reading processing is conducted, which continues from FIG. 4C;

FIG. 5A is a view showing that a mount paper for thumbnail, a thumbnail image for two pages, and a picture of a HDD are displayed;

FIG. 5B is a view showing that the thumbnail image moves towards the picture of the HDD;

FIG. 5C is a view showing that the thumbnail image overlaps with the picture of the HDD;

FIG. 5D is a view showing that the thumbnail image moves towards the picture of the HDD;

FIG. 5E is a view showing that the thumbnail image overlaps with the picture of the HDD;

FIG. 6A is a flowchart showing a successive page reading processing;

FIG. 6B is a flowchart showing the successive page reading processing, which continues from FIG. 6A;

FIG. 7A is a flowchart showing a display operation of the display section, an internal processing operation of a CPU, and an actual equipment operation of the image forming apparatus, when the successive page reading processing is conducted;

FIG. 7B is a flowchart showing the display operation of the display section, the internal processing operation of a CPU, and the actual equipment operation of the image forming apparatus, when the successive page reading processing is conducted, which continues from FIG. 7A;

FIG. 7C is a flowchart showing the display operation of the display section, the internal processing operation of a CPU, and the actual equipment operation of the image forming apparatus, when the successive page reading processing is conducted, which continues from FIG. 7B;

FIG. 8A is a view showing that a mount paper for thumbnail, a thumbnail image, and a picture of a HDD are displayed in the display section;

FIG. 8B is a view showing that a picture of a stamp is displayed;

FIG. 8C is a view showing that the picture of the stamp moves;

FIG. 8D is a view showing that the picture of the stamp is pressed on the thumbnail image;

FIG. 8E is a view showing that text of “Stamp” is pressed on the thumbnail image;

FIG. 8F is a view showing that the thumbnail image moves towards the location of the picture of the HDD, the thumbnail image being in a state in which the text of “Stamp” is added;

FIG. 9A is a flowchart showing a document reading and stamping processing;

FIG. 9B is a flowchart showing a document reading and stamping processing, which is a continuation of FIG. 9A;

FIG. 10A is a flowchart showing a display operation of the display section, an internal processing operation of a CPU, and an actual equipment operation of the image forming apparatus, when the document reading and stamping processing is conducted;

FIG. 10B a flowchart showing the display operation of the display section, the internal processing operation of a CPU, and the actual equipment operation of the image forming apparatus, when the document reading and stamping processing is conducted, which is a continuation of FIG. 10A;

FIG. 10C a flowchart showing the display operation of the display section, the internal processing operation of a CPU, and the actual equipment operation of the image forming apparatus, when the document reading and stamping processing is conducted, which is a continuation of FIG. 10C;

FIG. 11A is a view showing a document;

FIG. 11B is a view showing the document, platen of an image reading section, and a transfer paper size;

FIG. 11C is a view showing a screen which is displayed in a case where a transfer paper reading is selected;

FIG. 11D is a view showing that a document identified by the thumbnail image is being read; and

FIG. 11E is a view showing that the thumbnail image moves towards a picture of a HDD.

### DETAILED DESCRIPTION OF THE PREFERRED EMBODIMENTS

### First Embodiment

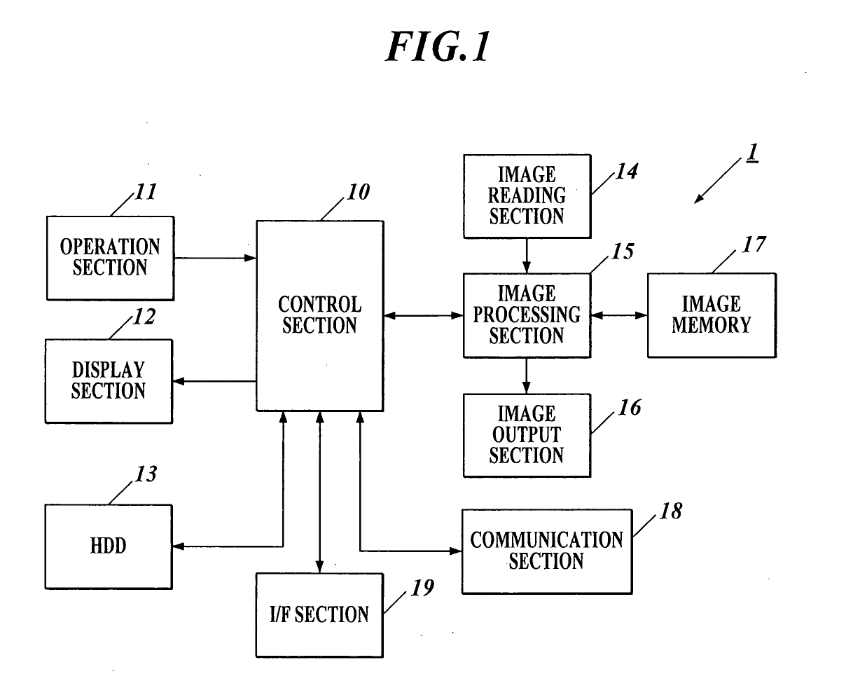

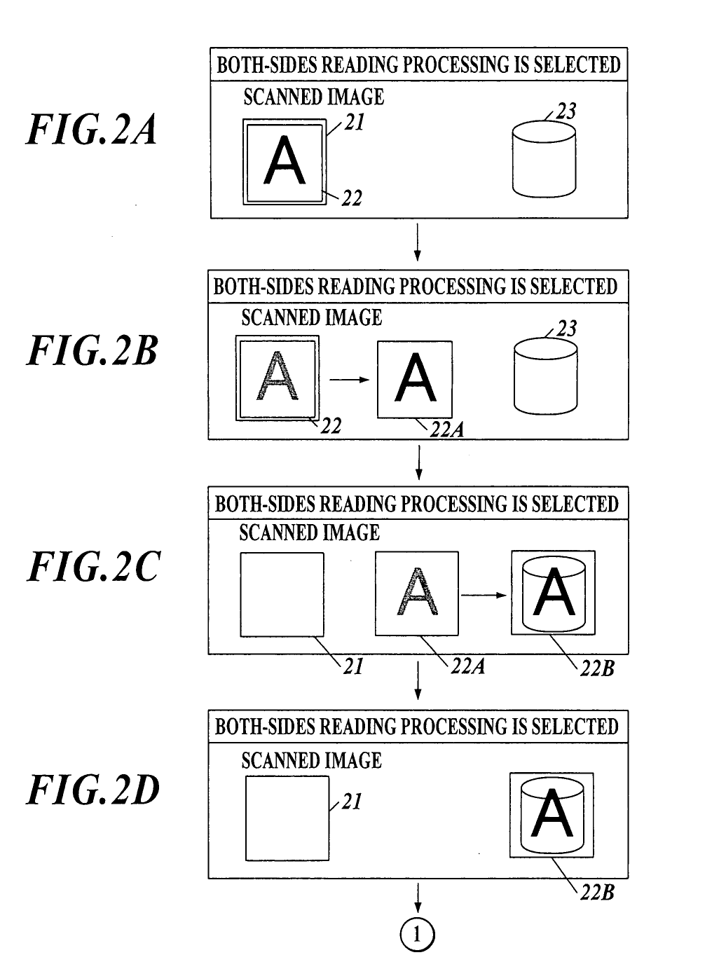

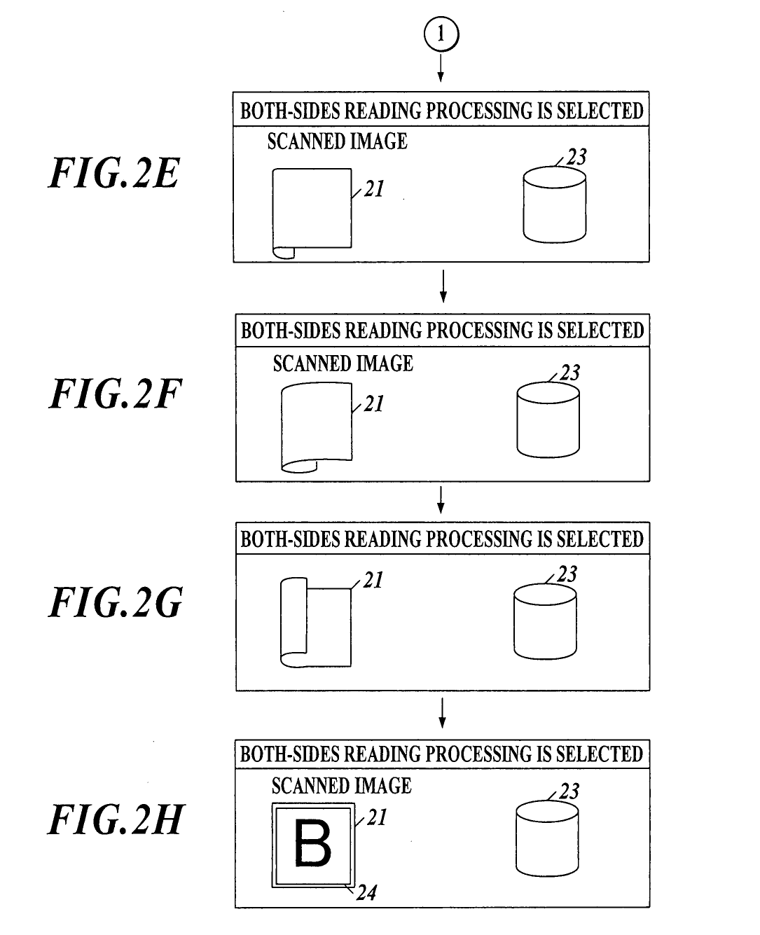

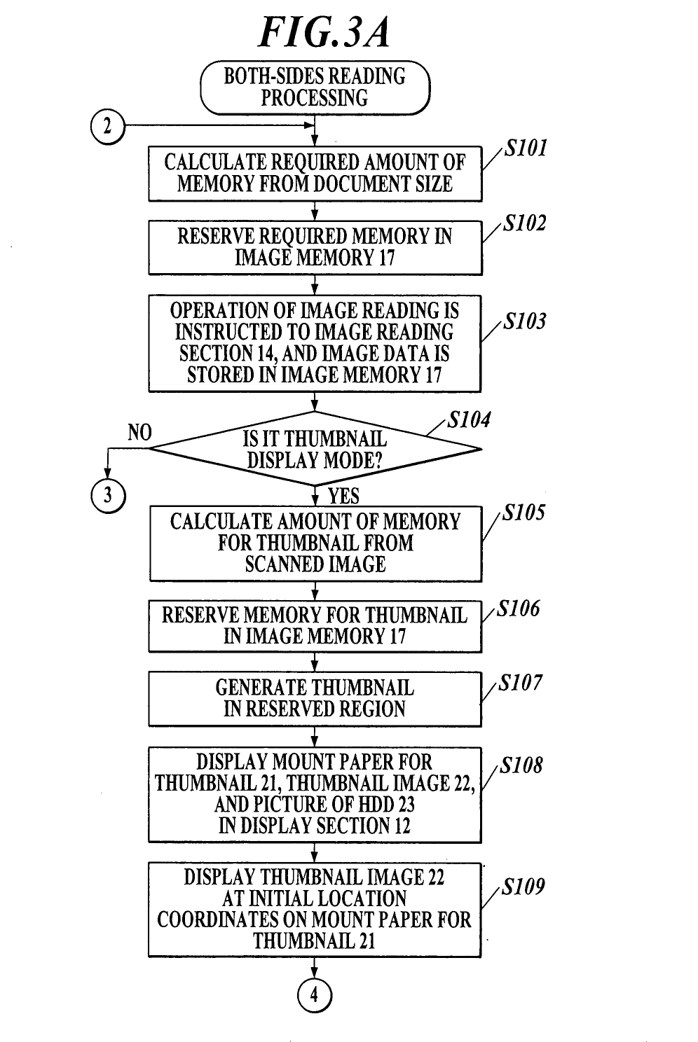

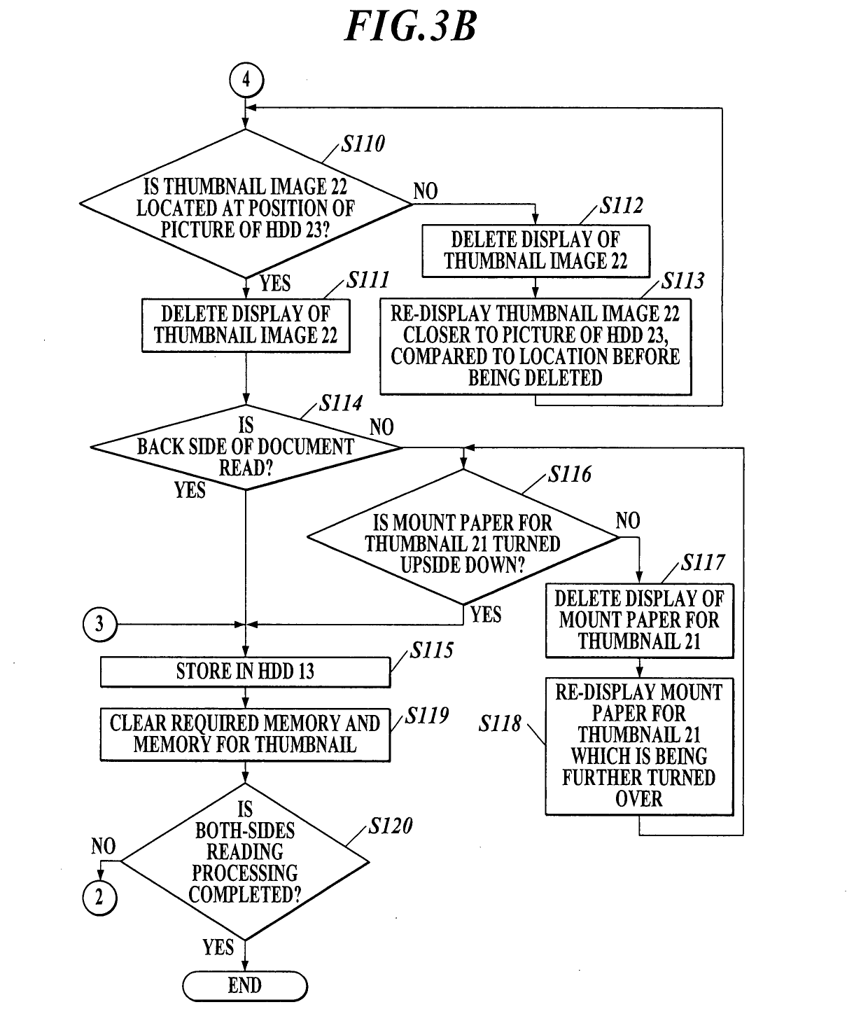

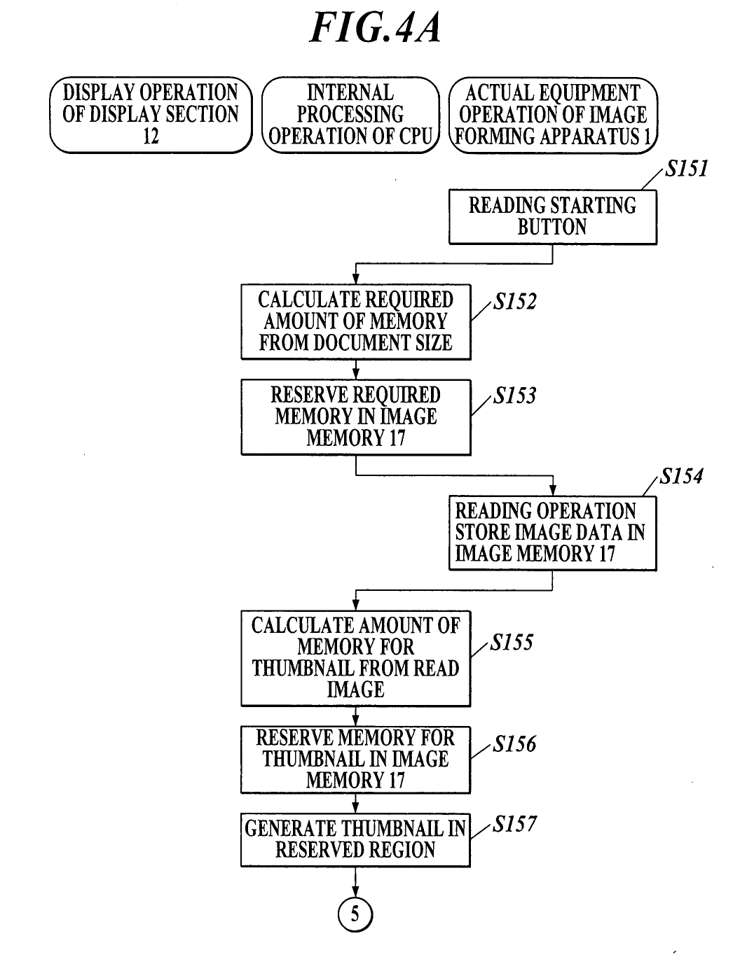

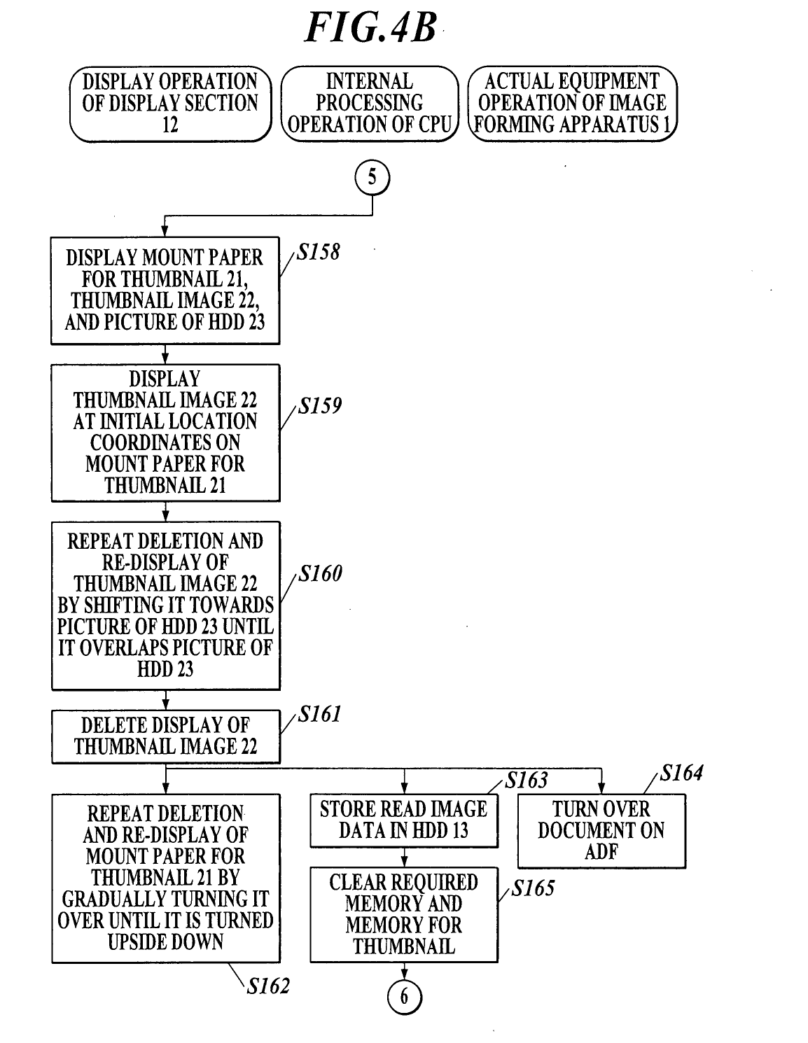

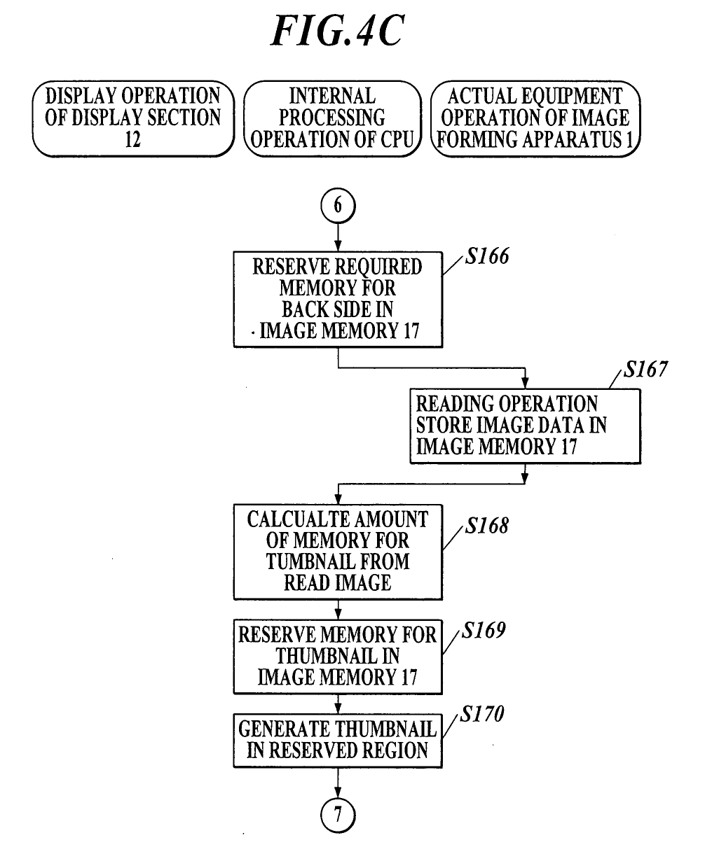

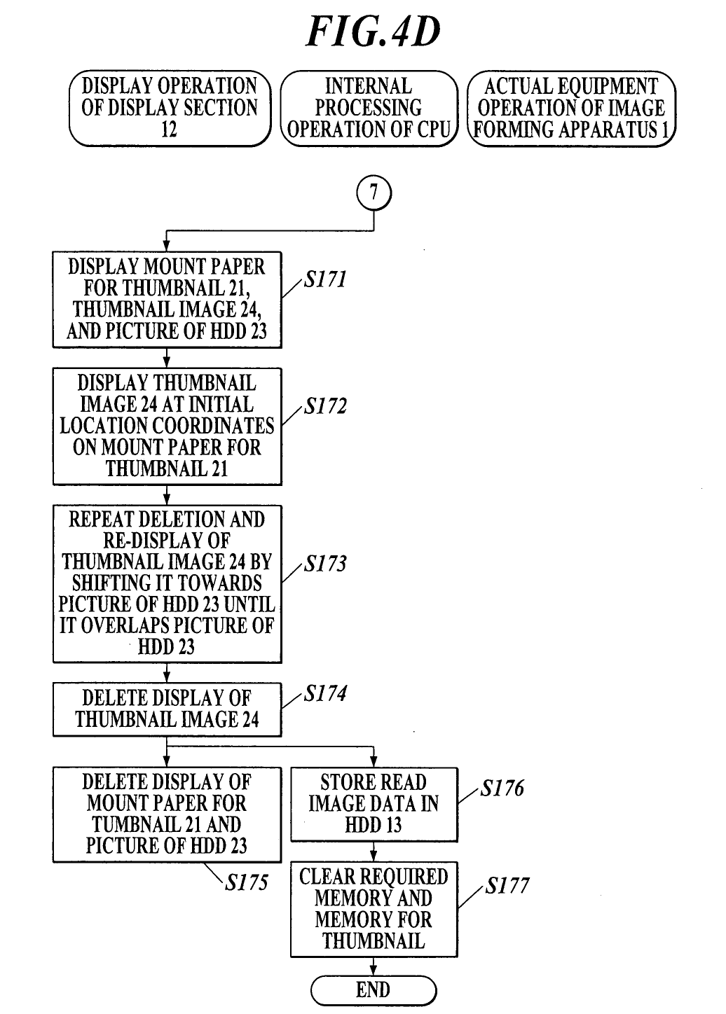

The first embodiment according to the present invention will be described. FIG. 1 shows an internal block diagram of an image forming apparatus 1 according to the present invention. FIGS. 2A through 2H show display screens that are displayed in a display section 12 according to the present embodiment. FIGS. 3A and 3B are flowcharts showing a both-sides reading processing. FIGS. 4A through 4D show operations of each of the sections that are performed when the both-sides reading processing is executed. First of all, apparatus structure of the present embodiment will be described with reference to FIG. 1. FIG. 1 shows the internal block diagram of the image forming apparatus 1 according to the present embodiment.

The image forming apparatus 1 is structured provided with a control section 10, an operation section 11, a display section 12, a Hard Disk Drive (HDD) 13, an image reading section 14, an image processing section 15, an image output section 16, an image memory 17, a communication section 18 and a I/F section 19.

The control section 10 is structured with a Central Processing Unit (CPU), a Read Only Memory (ROM), a Random Access Memory (RAM) and the like, and controls instructions with respect to each of the sections that construct the image forming apparatus 1, data communication between the sections, and the like. In particular, a program which is specified among a system program and various kinds of application programs stored in the ROM, is spread in the RAM and various kinds of processing are executed by collaboration of the program spread in the RAM with the CPU. Specifically, a both-sides image reading program described later is stored in the ROM.

In accordance with the both-sides reading program, the control section 10 displays images of both sides of a document, which is read by the image reading section 14, by a reduced image as a thumbnail. The control section 10 also displays an operation in which the read image is stored in the HDD 13, by a moving image.

The operation section 11 is structured with an operation input key, a touch panel, and the like, and outputs an operation signal such as a depression signal that corresponds to a key that is depressed, a position signal that corresponds to the position where the touch panel is contacted, and the like, to the control section 10.

The display section 12 is structured with a Cathode Ray Tube (CRT), a Liquid Crystal Display (LCD), and the like, and conducts output by displaying a display status of an image, an operation status of each of the sections, and the like, in accordance with display data which is output from the control section 10.

The HDD 13 is provided with a magnetic storing medium, and stores various kinds of information in a readable and writable manner in the magnetic storing medium, in accordance with an instruction from the control section 10. Image data read by the image reading section 14 and the like are stored in the HDD 13.

The image reading section 14 is provided with a platen glass, Charge Coupled Devices (CCD), and a light source. The image reading section 14 reads an image of a document by forming an image of a reflected light by using the CCD, the reflected light being a reflected light of a light which is scanned from the light source to a document set on an Auto Document Feeder (ADF), and conducting photoelectric conversion. Then the image reading section 14 generates image data of the image and outputs the data to the image processing section 15.

In accordance with an instruction from the control section 10, the image processing section 15 compresses the image data output from the image reading section 14 and the image data stored in the HDD 13, and temporarily stores them in a compressed memory of the image memory 17 by writing them as compressed image data.

In a case where an instruction to read out image data is sent from the control section 10, the compressed image data stored in the image memory 17 is decompressed, and is temporarily stored in the image memory 17. Subsequently, when output of printing is instructed from the control section 10, the image processing section 15 reads out non-compressed image data by a unit of page from a page memory, and conducts image processing such as scaling or direction converting of the image data. Thus, gray-scale (gradation) of the image data is controlled with pulse width by generating a Pulse Width Modulation (PWM) signal in accordance with the image data. The PWM signal is output to the image output section 16.

The image output section 16 is structured provided with a Laser Diode (LD), a photoconductive drum, a charging member, a developing member, a transfer member, a fixing member, a paper supply tray to supply transfer paper, a paper feeding roller to feed the transfer paper along a feeding route, and the like. The image output section 16 can be an ink jet type, a thermal transfer type, or other printing type.

In particular, in accordance with an instruction from the image processing section 15, the image output section 16 supplies a transfer paper, which is within a predetermined size and direction, from one of the paper supply trays, and feeds the transfer paper on the feeding route. Subsequently, the image output section 16 charges the surface of the photoconductive drum by the charging member, forms an electrostatic latent image by irradiating a laser beam to the surface of the photoconductive drum by the LD, in accordance with the PWM signal input from the image processing section 15. Then the image output section 16 and adheres toner to a region of the surface of the photoconductive drum that includes the electrostatic latent image, by the developing member. Further, an image is formed by the transfer member transferring the toner on the transfer paper which is fed from the paper supply tray, and the image is fixed by the fixing member.

The image memory 17 is structured with a Dynamic RAM (DRAM), and includes a compressed memory to temporarily store compressed image data, and a page memory to temporarily store non-compressed image data which is subject to output, before performing output of printing.

The communication section 18 is a functional section to communicate data with external devices through a communication line, and is structured with a modem, a LAN interface, a USB, and the like. The I/F section 19 is a functional section to communicate data with connected external devices not shown, and is structured with a serial interface and the like.

Next, display screen which is displayed in the display section 12 according to the present embodiment will be described with reference to FIGS. 2A through 2H. First of all, as shown in FIG. 2A, a mount paper for thumbnail 21, a thumbnail image of a front side 22, and a picture of the HDD 23 are displayed in the display section 12. Here, the thumbnail image of the front side 22 is “A”. Further, a message of “both-sides reading is selected” is displayed in the display section 12.

As shown in FIG. 2B, the thumbnail image 22 moves to a location of 22A. Subsequently, as shown in FIG. 2C, the thumbnail image 22 moves from the location of 22A to a location of 22B. As shown in FIG. 2D, when the thumbnail image 22 moves to the location of 22B, the thumbnail image 22 overlaps with the picture of the HDD 23. This figure shows that image data of the front side is stored in the HDD 13.

Then, as shown in FIGS. 2E through 2G, the mount paper for thumbnail 21 is turned over. As shown in FIG. 2H, a thumbnail image of a back side 24 is displayed on the mount paper for thumbnail 21 which is turned upside down. Here, the thumbnail image of the back side 24 is “B”. Images similar to FIGS. 2A through 2D are displayed in the display section 12 accordingly.

Next, the both-sides reading processing executed at the image forming apparatus 1 will be described with reference to FIGS. 3A and 3B. In the both-sides reading processing, images of both sides of the document that is read by the image reading section 14 are displayed as thumbnails, and an operation in which the read images are stored in the HDD 13, is displayed by a moving image.

For example, being triggered by an input of execution instruction of the both-sides reading processing through the operation section 11 by a user, the both-sides reading processing is executed at the image forming apparatus 1 by collaboration of a both-sides image reading program with the CPU, the both-sides image reading program being read out from the ROM and being spread in the RAM as needed, in the control section 10.

First of all, required amount of memory is calculated from a document size of the document which is subject to reading (step S101). Here, the required amount of memory is an amount of memory required when storing the image read from the document. The image read from the document is read in a bitmap form, and the required amount of memory is calculated. Subsequently, required memory is reserved in the image memory 17 (step S102). Then, operation of image reading is instructed to the image reading section 14, and image data is stored in the image memory 17 (step S103).

After execution of step S103, it is determined whether it is a thumbnail display mode or not (step S104). In a case where it is not the thumbnail display mode (step S104; No), it moves on to step S115. In a case where it is the thumbnail mode (step S104; Yes), amount of memory for thumbnail is calculated from the read image (step S105). Here, the amount of memory for thumbnail is an amount of memory required when the read image is displayed as thumbnail. After execution of step S105, memory for thumbnail is reserved in the image memory 17 (step S106). Then, a thumbnail is generated in the reserved region (step S107).

Subsequently, the mount paper for thumbnail 21, the thumbnail image 22, and the picture of the HDD 23 are displayed in the display section 12 (step S108). The thumbnail image 22 is displayed at the initial location coordinates of the mount paper for thumbnail 21 (step S109). This step corresponds to FIG. 2A.

Then, it is determined whether the thumbnail image 22 is located at a position of the picture of the HDD 23 or not (step S110). In a case where the thumbnail image 22 is located at the position of the picture of the HDD 23 (step S110; Yes), the display of the thumbnail image 22 is deleted (step S111). In a case where the thumbnail image 22 is not located at the position of the picture of the HDD 23 (step S110; No), the display of the thumbnail image 22 is deleted (step S112). Subsequently, the thumbnail image 22 is re-displayed at coordinates that are closer to the picture of the HDD 23, compared with those before being deleted (step S113). Steps S112 and S113 correspond to FIGS. 2B and 2C. After execution of step S113, it moves on to step S110.

Then, it is determined whether back side of the document has been read or not (step S114). This step corresponds to a step that determines whether the thumbnail image “B” of the back side, shown in FIG. 2H, has been read or not. In a case where it is determined that the back side has been read (step S114; Yes), the read image is stored in the HDD 13 (step S115).

In a case where it is determined that the back side has not been read (step S114; No), it is determined whether the mount paper for thumbnail 21 is turned upside down or not (step S116). In a case where it is determined that the mount paper for thumbnail 21 is turned upside down (step S116; Yes), it moves on to step S115. In a case where it is determined that the mount paper for thumbnail 21 is not turned upside down (step S116; No), the display of the mount paper for thumbnail 21 is deleted (step S117). Subsequently, the mount paper for thumbnail 21 is re-displayed by being further turned over, compared to the mount paper for thumbnail before being deleted (step S118). The steps S117 and S118 correspond to FIGS. 2E through 2G. After execution of step S118, it moves on to step S116.

After execution of step S115, the required memory and the memory for thumbnail in the image memory 17 are cleared (step S 119). Then, it is determined whether the both-sides reading processing has been completed or not (step S120). In a case where it is determined that it is not completed (step S120; No), it moves on to step S101. In a case where it is determined that it is completed (step S120; Yes), the both-sides reading processing is finished.

Next, a display operation of the display section 12, an internal processing operation of the CPU, and an actual equipment operation of the image forming apparatus 1, when the both-sides reading processing is conducted, will be described with reference to FIGS. 4A through 4D.

First of all, an operation to depress a scan starting button is conducted by a user through the operation section 11 at the image forming apparatus 1 (step S151). This step corresponds to instructing execution of the both-sides reading processing. When step S151 is executed, the required amount of memory is calculated from the size of the document at the CPU (step S152). Then, the required memory is reserved in the image memory 17 (step S153). After execution of step S153, reading operation is conducted by the image reading section 14 at the image forming apparatus 1, and the read image data is stored in the image memory 17 (step S154).

After execution of step S154, the amount of memory for thumbnail is calculated from the read image at the CPU (step S155). After execution of step S155, the memory for thumbnail is reserved in the image memory 17 (step S156). Then, the thumbnail is generated in the reserved region (step S157).

After execution of step S157, the mount paper for thumbnail 21, the thumbnail image 22 and the picture of the HDD 23 are displayed in the display section 12 (step S158). The thumbnail image 22 is displayed at the initial location coordinates of the mount paper for thumbnail 21 (step S159). After execution of step S159, deletion and re-display of the thumbnail image 22 is repeated by shifting the thumbnail image 22 towards the picture of the HDD 23, until the thumbnail image 22 overlaps with the picture of the HDD 23 (step S160). Then, the display of the thumbnail image 22 is deleted (step S161). After execution of step S161, deletion and re-display of the mount paper for thumbnail 21 is repeated by gradually turning it over, until the mount paper for thumbnail 21 is turned upside down to the back side (step S162).

After execution of step S161, the read image data is stored in the HDD 13 at the CPU (step S163). In addition, after execution of step S161, the document on the ADF is turned upside down at the image forming apparatus 1 (step S164). Here, steps S162 and S164 are conducted simultaneously. This indicates that the operation in which both sides of the document is read is displayed by the moving image using the thumbnail, and the operation in which image is read by the image reading section 14, are synchronized.

After execution of step S163, the required memory and the memory for thumbnail in the image memory 17 are cleared at the CPU (step S165). Then, a required memory for the back side is reserved in the image memory 17 (step S166). After execution of step S166, at the image forming apparatus 1, operation of image reading is conducted by the image reading section 14, and the read image data is stored in the image memory 17 (step S167). After execution of step S167, at the CPU, required amount of memory for thumbnail is calculated from the read image (step S168). After execution of step S168, memory for thumbnail is reserved in the image memory 17 (step S169). Then, thumbnail is generated in the reserved region (step S170).

After execution of step S170, the mount paper for thumbnail 21, the thumbnail image 24 and the picture of the HDD 23 are displayed in the display section 12 (step S171). The thumbnail image 24 is displayed at the initial location coordinates of the mount paper for thumbnail 21 (step S172). After execution of step S172, deletion and re-display of the thumbnail image 24 is repeated by shifting the thumbnail image 24 towards the picture of the HDD 23, until the thumbnail image 24 overlaps with the picture of the HDD 23 (step S173). Then, the thumbnail image 24 is deleted (step S174). After execution of step S174, displays of the mount paper for thumbnail 21 and the picture of the HDD 23 are deleted (step S175).

After execution of step S174, at the CPU, the read image data is stored in the HDD 13 (step S176). Then, the required memory and the memory for thumbnail are cleared (step S177). After execution of step S177, operations of each of the sections are finished.

As described above, according to the present embodiment, operation of both-sides reading can be displayed on the display section 12 by a moving image using thumbnail images 22 and 24. Therefore, the image forming apparatus 1 which is capable of allowing a user to confirm that the image reading intended by the user is conducted, can be realized. In a case where the read image has a failure in reading, the user can recognize the failure in the both-sides reading operation when the image is being read. Accordingly, the user can interrupt the reading operation and make the image forming apparatus 1 conduct the intended image reading operation.

Further, the moving image using thumbnail images 22 and 24 can indicate that the image read by the image reading section is stored in the HDD 13. Therefore, in a case where the user recognizes a failure in reading when the image is being read, the user can interrupt the reading operation and make the image forming apparatus 1 conduct the intended image reading operation.

The operation of reading images on both sides of a document can be displayed by the moving image, using the thumbnails 22 and 24, on the display section 12. Therefore, it can be confirmed whether top and bottom of the read image is correct or not, when the image is being read.

The operation in which the both-sides reading operation of the document is displayed in the display section 12 by the moving image using the thumbnails 22 and 24, can be synchronized with the operation of image reading. Therefore, in a case where the user recognizes a failure in reading when the image is being read, the user can interrupt the reading operation and make the image forming apparatus 1 conduct the intended image reading operation.

### Second Embodiment

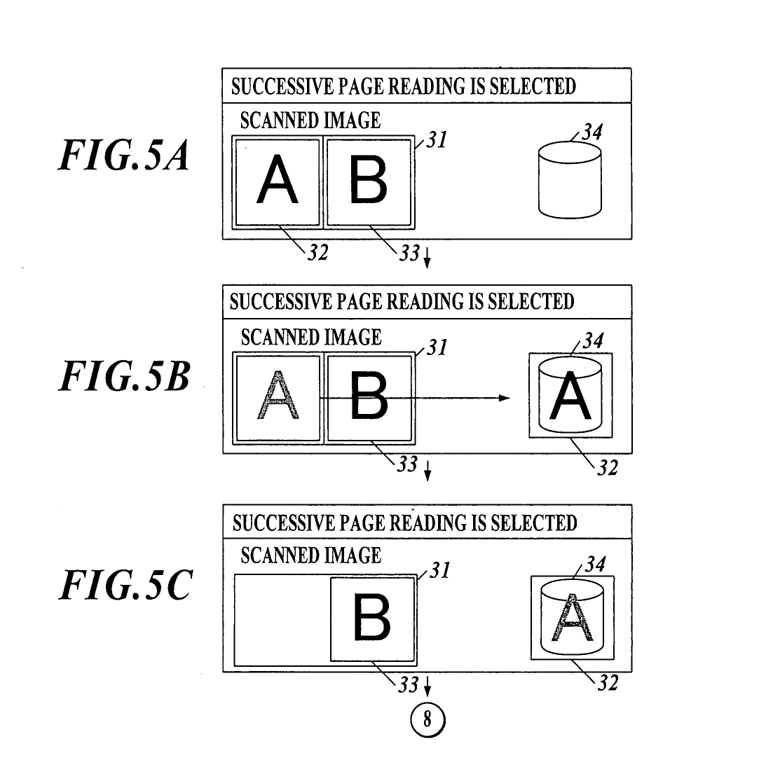

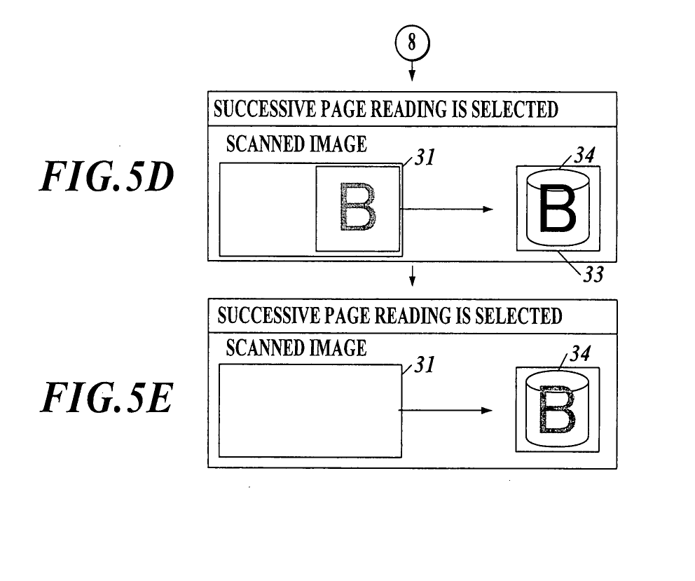

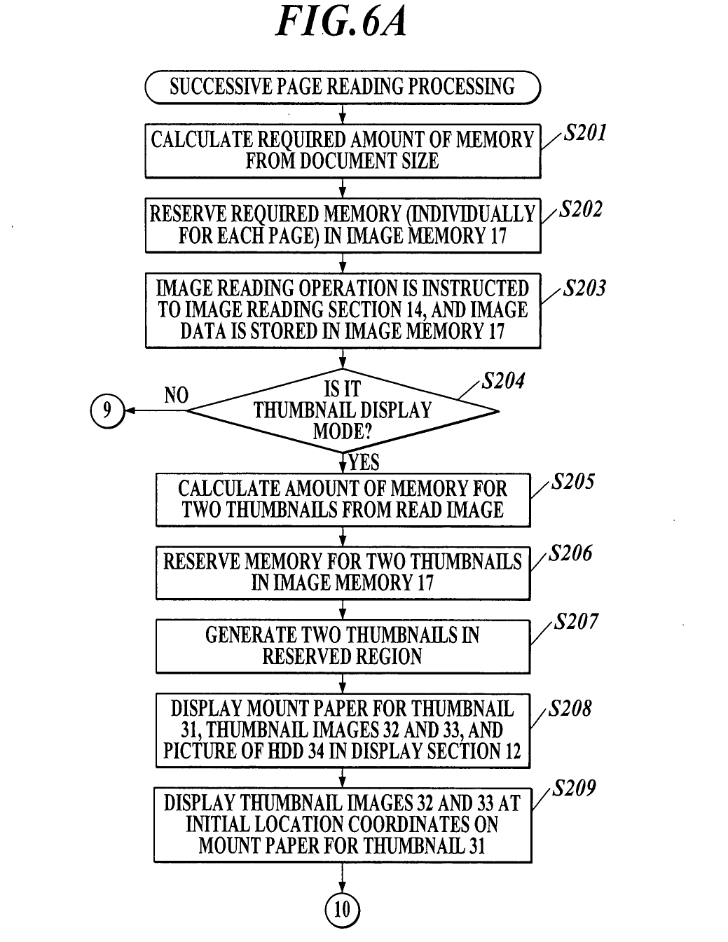

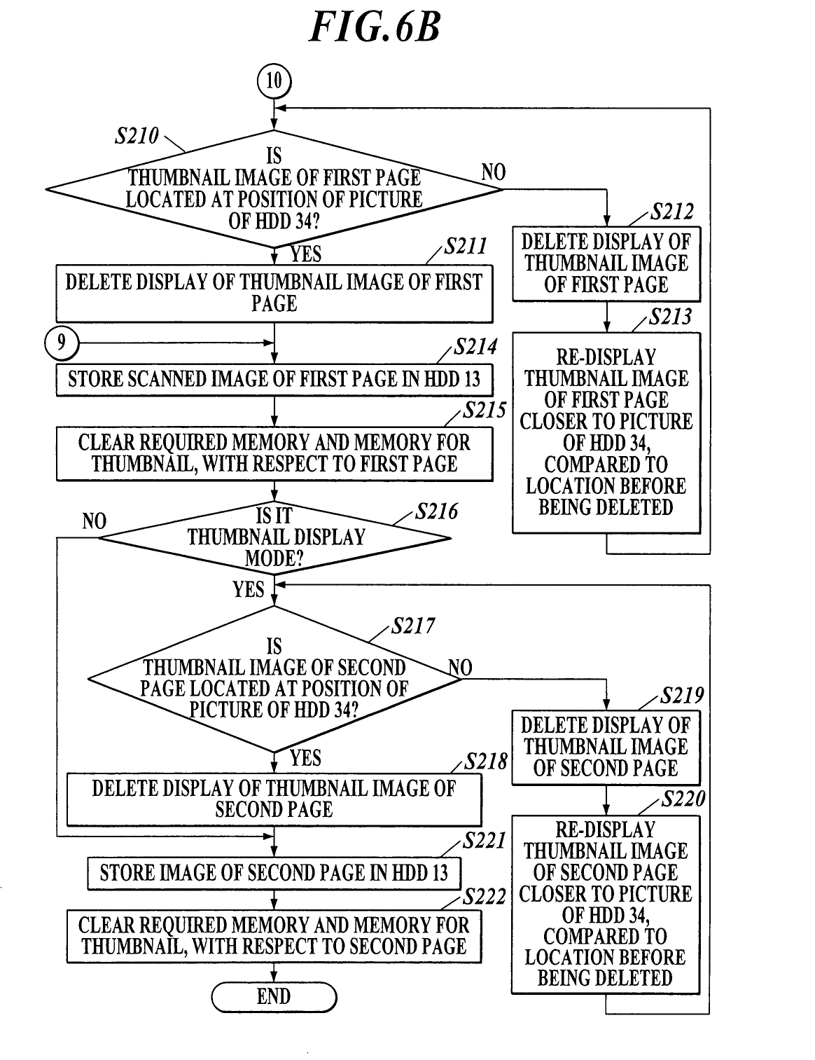

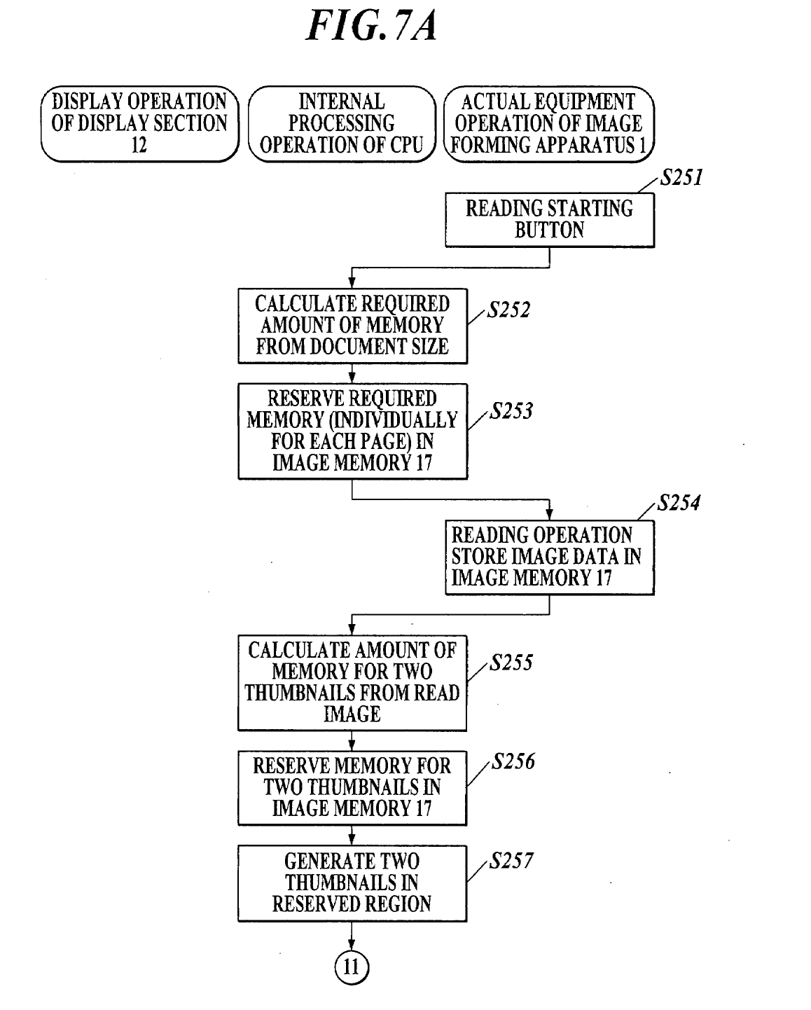

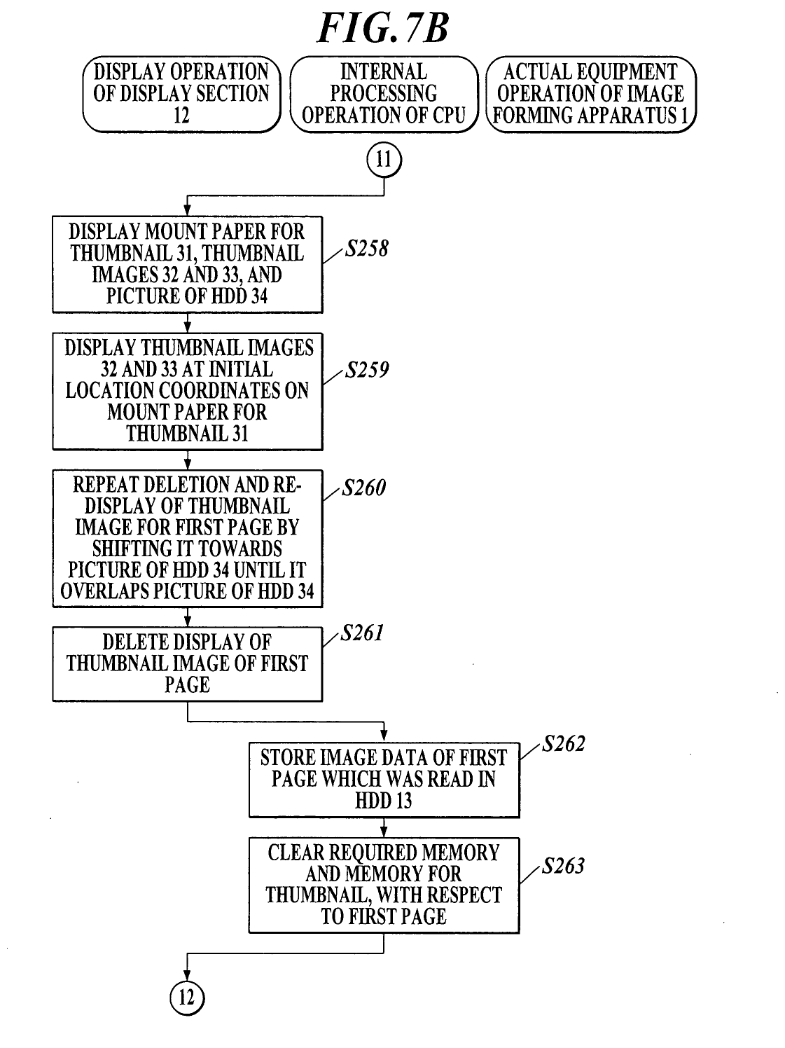

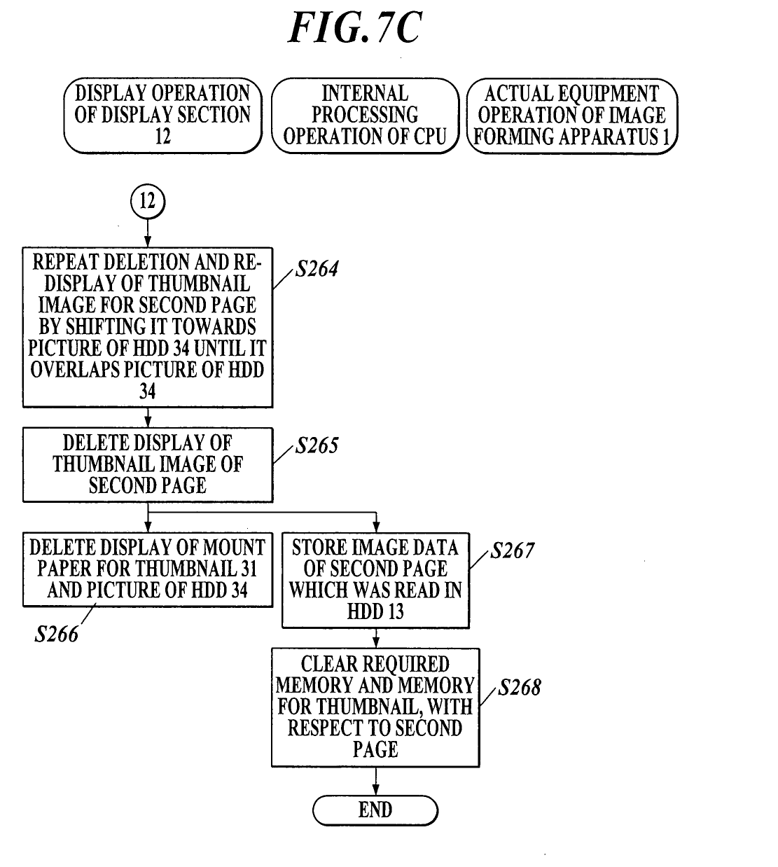

The second embodiment according to the present invention will be described. FIGS. 5A through 5E show display screens that are displayed at the display section 12 in the second embodiment. FIGS. 6A and 6B show successive page reading processing. FIGS. 7A through 7C show operations of each of the sections when the successive page reading processing is executed.

As for the apparatus structure of the second embodiment, the image forming apparatus 1 is used in a similar manner as the first embodiment, and the same reference symbol is used for the same structure component. Hereinafter, only the portions that are different from the first embodiment will be described.

At the image forming apparatus 1, a successive page reading program is stored in the ROM of the control section 10.

The display screen which is displayed at the display section 12 in the second embodiment will be described with reference to FIGS. 5A through 5E. First of all, as shown in FIG. 5A, a mount paper for thumbnail 31, thumbnail images 32 and 33 for two pages of document, a picture of the HDD 34 are displayed in the display section 12. Here, thumbnail image of one page 32 is “A”, and thumbnail image of another page 33 is “B”. In addition, a message of “successive page reading is selected” is displayed in the display section 12.

Subsequently as shown in FIG. 5B, the thumbnail image 32 moves to the location of the picture of the HDD 34. When the thumbnail image 32 moves to the location of the picture of the HDD 34, the thumbnail image 32 overlaps with the picture of the HDD 34, as shown in FIG. 5C. This figure indicates that a read image that corresponds to the thumbnail image 32 is stored in the HDD 13.

As shown in FIG. 5D, the thumbnail image 33 moves to the location of the picture of the HDD 34. When the thumbnail image 33 moves to the location of the picture of the HDD 34, the thumbnail image 33 overlaps with the picture of the HDD 34, as shown in FIG. 5E. This figure indicates that a read image that corresponds to the thumbnail image 33 is stored in the HDD 13.

Next, the successive page reading processing executed by the image forming apparatus 1 will be described with reference to FIGS. 6A and 6B. In the successive page reading processing, images read by the image reading section 14 are successively displayed as thumbnail images, and an operation in which the read images are stored in the HDD 13 is displayed by a moving image.

For example, being triggered by an input of execution instruction of the successive page reading processing through the operation section 11 by a user, the successive page reading processing is executed at the image forming apparatus 1 by collaboration of a successive page reading program with the CPU, the successive page reading program being read out from the ROM and being spread in the RAM as needed, at the control section 10.

First of all, required amount of memory is calculated from the size of a document subject to reading (step S201). Then, a required memory is reserved in the image memory 17. Here, memory is reserved individually for two pages, wherein each page has half the size of the document size (step S202). Then, instruction to read image is sent to the image reading section 14, and the read image is stored in the image memory 17 (step S203).

After execution of step S203, it is determined whether it is a thumbnail display mode or not (step S204). In a case where it is not the thumbnail display mode (step S204; No), it moves on to step S214. In a case where it is the thumbnail display mode (step S204; Yes), amount of memory for two thumbnails is calculated from the read image (step S205). After execution of step S205, memories for two thumbnails are reserved in the image memory 17 (step S206). Then, two thumbnails are generated in the reserved region (step S207).

Subsequently, the mount paper for thumbnail 31, the thumbnail images 32 and 33, and the picture of the HDD 34 are displayed in the display section 12 (step S208). The thumbnail images 32 and 33 are each displayed in the initial location coordinates of the mount paper for thumbnail 31 (step S209). This step corresponds to FIG. 5A.

Then, it is determined whether a thumbnail image of a first page, which is the thumbnail image 32, is located at a position of the picture of the HDD 34 or not (step S210). In a case where the thumbnail image of the first page is located at the position of the picture of the HDD 34 (step S210; Yes), the display of the thumbnail image of the first page is deleted (step S211). In a case where the thumbnail image of the first page is not located at the position of the picture of the HDD 34 (step S210; No), the display of the thumbnail image of the first page is deleted (step S212). Subsequently, the thumbnail image of the first page is re-displayed at a position that is closer to the coordinates of the picture of the HDD 34, compared with that before being deleted (step S213). This step corresponds to FIG. 5B. After execution of step S213, it goes on to step S210.

After execution of step S211, the read image of the first page is stored in the HDD 13 (step S214). This step corresponds to FIG. 5C. After execution of step S214, required memory for the first page of the document and the memory for thumbnail image of the first page are cleared (step S215).

After execution of step S215, it is determined whether it is a thumbnail display mode or not (step S216). In a case where it is determined that it is the thumbnail display mode (step S216; Yes), it is determined whether a thumbnail image of a second page, which is the thumbnail image 33, is located at a position of the picture of the HDD 34 or not (step S217). In a case where the thumbnail image of the second page is located at the position of the picture of the HDD 34 (step S217; Yes), the display of the thumbnail image of the second page is deleted (step S218). In a case where the thumbnail image of the second page is not located at the position of the picture of the HDD 34 (step S217; No), the display of the thumbnail image of the second page is deleted (step S219). Subsequently, the thumbnail image of the second page is re-displayed at coordinates that are closer to the picture of the HDD 34, compared with those before being deleted (step S220). This step corresponds to FIG. 5D. After execution of step S220, it goes on to step S217.

After execution of step S218, the read image of the second page is stored in the HDD 13 (step S221). This step corresponds to FIG. 5E. After execution of step S221, required memory for the second page of the document and the memory for thumbnail image of the second page are cleared (step S222). After execution of step S222, the successive page reading processing is finished.

Next, a display operation of the display section 12, an internal processing operation of the CPU, and an actual equipment operation of the image forming apparatus 1, when the successive page reading processing is conducted, will be described with reference to FIGS. 7A through 7C.

First of all, an operation of depressing a reading starting button is conducted by a user through the operation section 11 at the image forming apparatus 1 (step S251). This step corresponds to instructing execution of the successive page reading processing. When step S251 is executed, the required amount of memory is calculated from the size of the document at the CPU (step S252). Then, the required memory (individually for two pages, each page having half the size of the document size) is reserved in the image memory 17 (step S253). After execution of step S253, reading operation is conducted by the image reading section 14 at the image forming apparatus 1, and the read image data is stored in the image memory 17 (step S254).

After execution of step S254, the amount of memory for two thumbnails is calculated from the read image at the CPU (step S255). After execution of step S255, the memory for two thumbnails is reserved in the image memory 17 (step S256). Then, two thumbnails are generated in the reserved region (step S257).

After execution of step S257, the mount paper for thumbnail 31, the thumbnail images 32 and 33, and the picture of the HDD 34 are displayed in the display section 12 (step S258). The thumbnail images 32 and 33 are displayed in the initial location coordinates of the mount paper for thumbnail 31 (step S259). After execution of step S259, deletion and re-display of the thumbnail image of the first page, which is the thumbnail image 32, is repeated by shifting the thumbnail image of the first page towards the picture of the HDD 34, until the thumbnail image of the first page overlaps the picture of the HDD 34 (step S260). Then, display of the thumbnail image of the first page is deleted (step S261).

After execution of step S261, image data of the first page which is read is stored in the HDD 13 by the CPU (step S262). Then, required memory for the first page of the document and the memory for thumbnail image of the first page are cleared (step S263).

After execution of step S263, at the display section 12, deletion and re-display of the thumbnail image of the second page, which is the thumbnail image 33, is repeated by shifting the thumbnail image of the second page towards the picture of the HDD 34, until the thumbnail image of the second page overlaps the picture of the HDD 34 (step S264). Then, display of the thumbnail image of the second page, which is the thumbnail image 33, is deleted (step S265). Subsequently, displays of the mount paper for thumbnail 31 and the picture of the HDD 34 are deleted (step S266).

After execution of step S265, read image data of the second page is stored in the HDD 13 at the CPU (step S267). Then, required memory for the second page of the document and the memory for thumbnail image of the second page are cleared (step S268). After execution of step S268, operations of each of the sections are finished.

As described above, according to the second embodiment, operation relating to the successive page reading can be displayed in the display section 12 by the moving image using the thumbnail images 32 and 33. Therefore, the image forming apparatus 1 which is capable of allowing a user to confirm that an image reading intended by the user is conducted, can be realized. For example, in a case where the read image has a failure in reading, the user can recognize the failure in the read image when the image is being read by the successive page reading processing. Accordingly, the user can interrupt the reading operation and make the image forming apparatus 1 conduct the intended image reading operation.

Further, the moving image using thumbnail images 32 and 33 can indicate that the image read by the image reading section 14 is stored in the HDD 13. Therefore, in a case where the user recognizes a failure in reading when the image is being read, the user can interrupt the reading operation and make the image forming apparatus 1 conduct the intended image reading operation.

The operation of successive page reading can be displayed by the moving image using the thumbnail image, on the display section 12. Therefore, it can be confirmed whether top and bottom of the read image is correct or not, when the image is being read.

### Third Embodiment

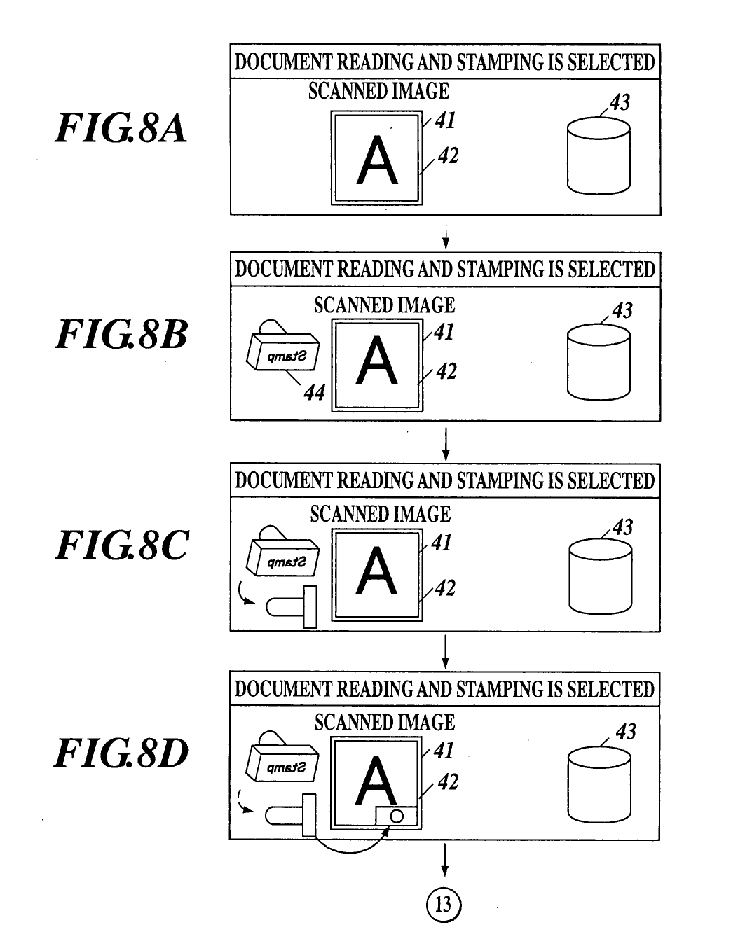

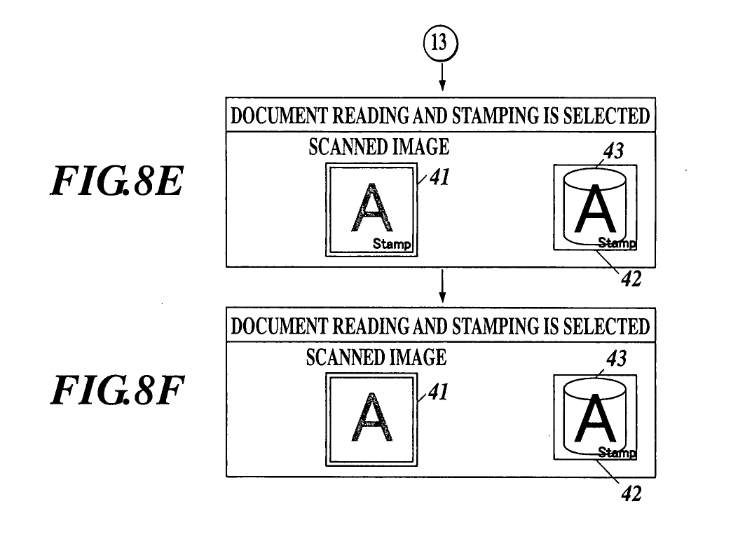

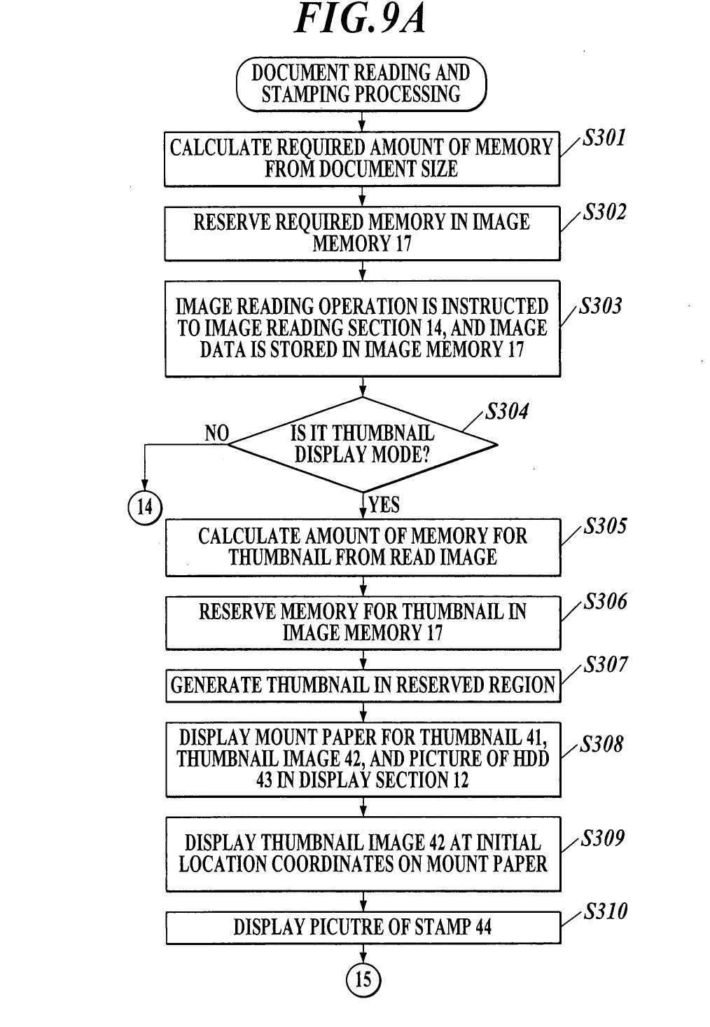

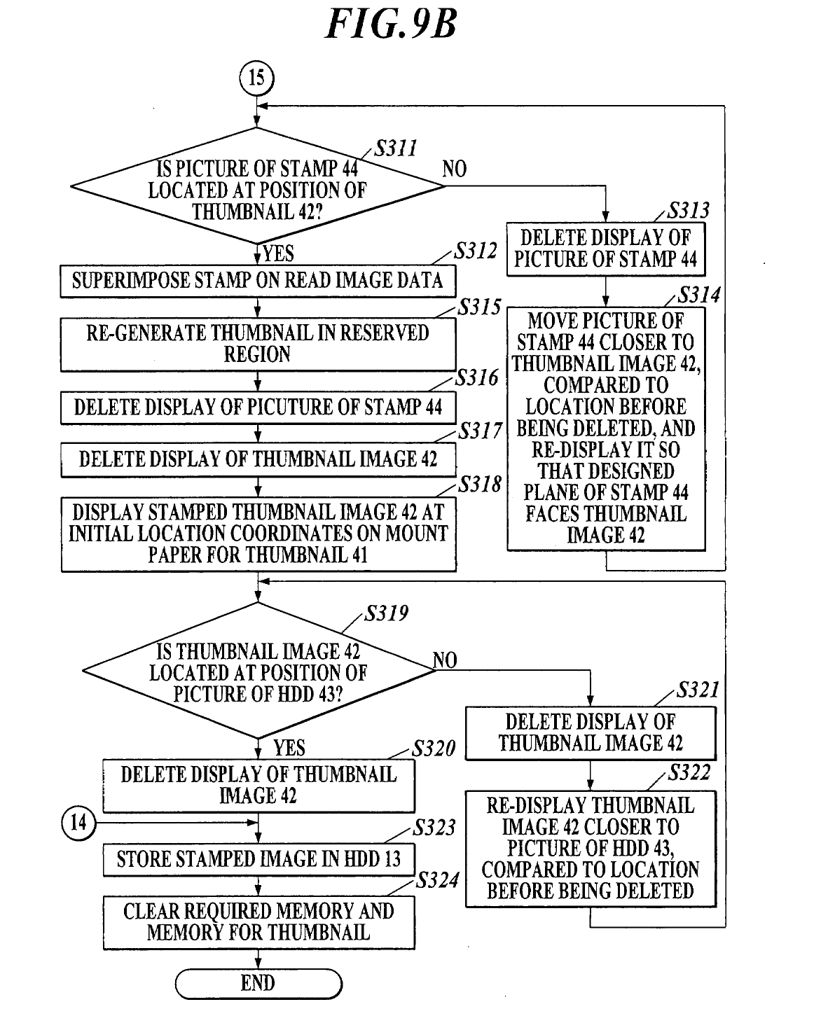

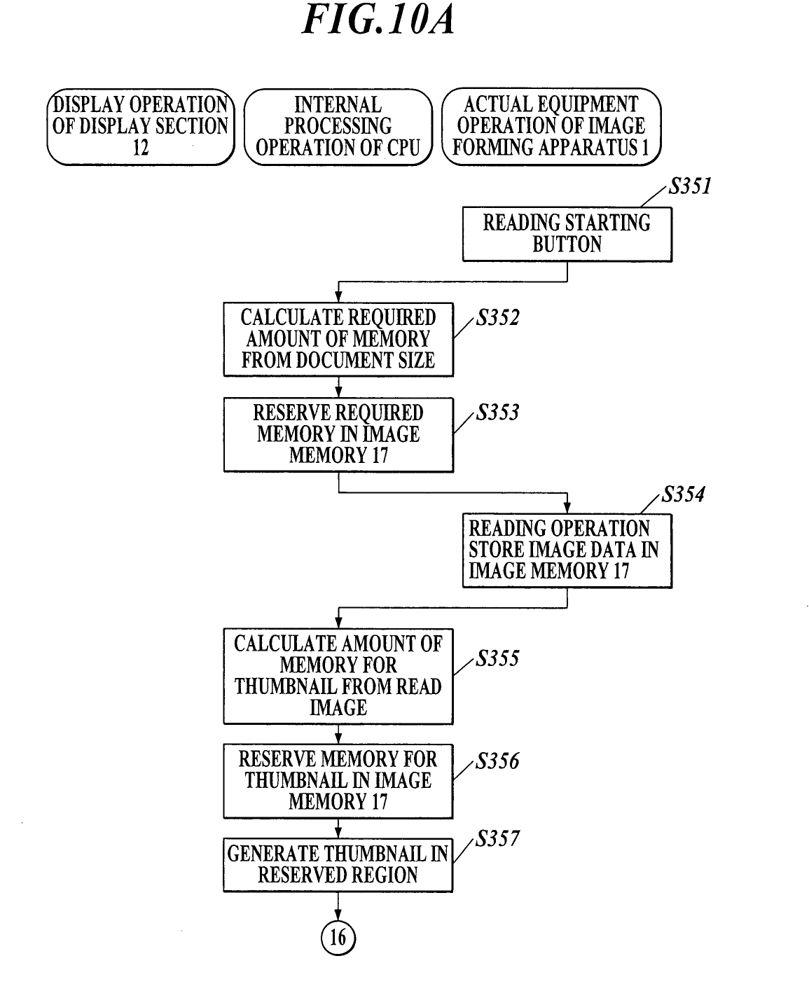

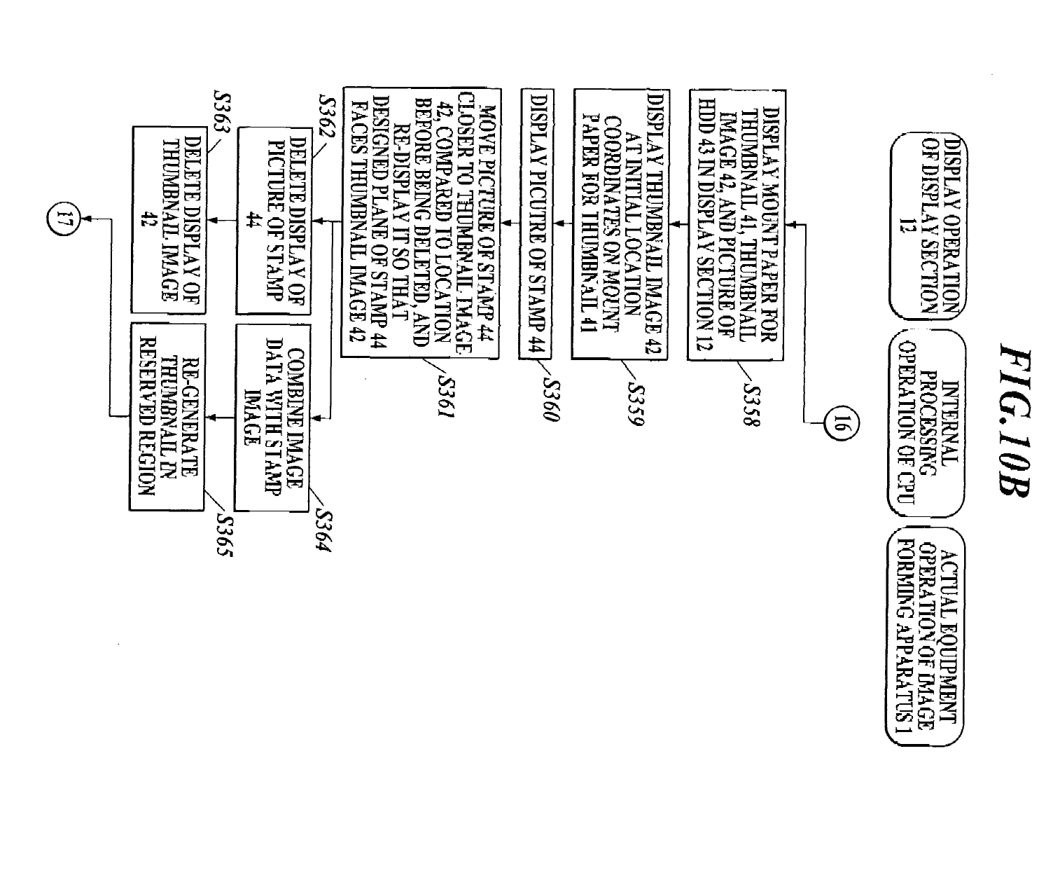

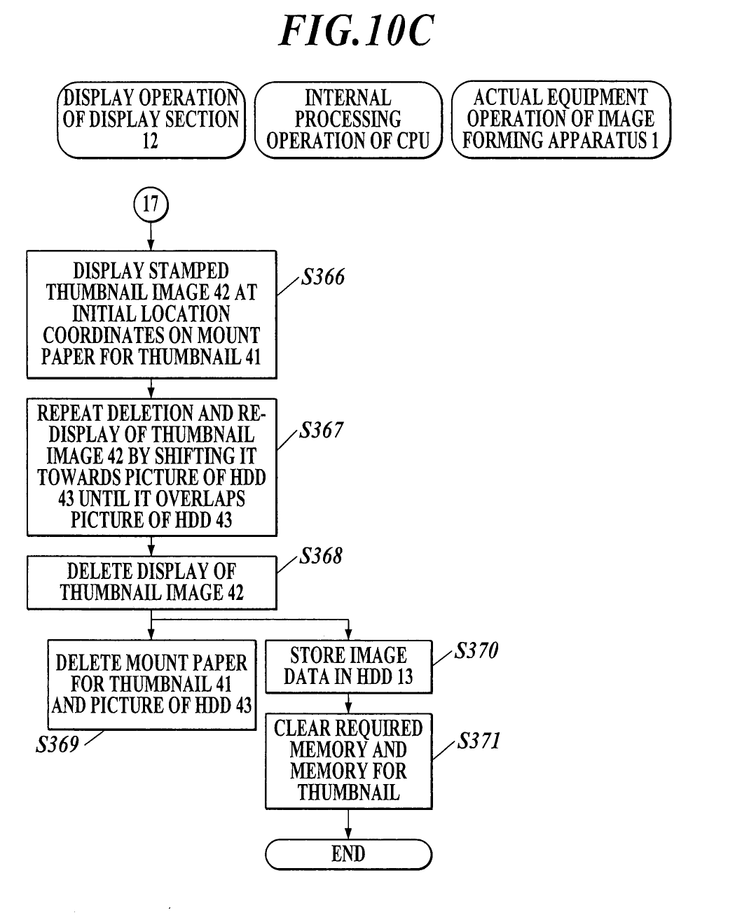

The third embodiment according to the present invention will be described. FIGS. 8A through 8E and FIG. 12 show display screens that are displayed in the display section 12 in the third embodiment. FIGS. 9A and 9B are flowcharts showing a document reading and stamping processing. FIGS. 10A through 10C show operations of each of the sections when the document reading and stamping processing is executed.

As for the apparatus structure of the third embodiment, the image forming apparatus 1 is used in a similar manner aw the first embodiment, and the same reference symbol is used for the same structure component. Hereinafter, only the portions that are different from the first embodiment will be described.

At the image forming apparatus 1, a document reading and stamping program is stored in the ROM of the control section 10.

The display screen which is displayed in the display section 12 in the third embodiment will be described with reference to FIGS. 8A through 8F. First of all, as shown in FIG. 8A, a mount paper for thumbnail 41, a thumbnail image 42, and a picture of the HDD 43 are displayed in the display section 12. Here, the thumbnail image 42 is “A”. In addition, a message of “document reading and stamping is selected” is displayed in the display section 12.

Subsequently, as shown in FIG. 8B, a picture of a stamp 44 is displayed. Here, as for information to be included in the stamp, company name, document number, date, and the like are provided. In the present embodiment, explanation will be given by making a text “Stamp” be stamped as the information of the stamp. Therefore, text of “Stamp” is displayed in the picture of the stamp 44. The picture of the stamp 44 moves as shown in FIG. 8C, and the stamp is stamped on the thumbnail image 42 as shown in FIG. 8D. FIG. 8E indicates that the text “Stamp” has been stamped on the thumbnail image 42. Then, as shown in FIG. 8F, the thumbnail image 42 moves to the location where the picture of the HDD 43 is positioned, in a state where the text “Stamp” is stamped on the thumbnail image 42. This figure indicates that a read image that corresponds to the thumbnail image 42 is stored in the HDD 13.

Next, the document reading and stamping processing which is executed by the image forming apparatus 1 will be described with reference to FIGS. 9A and 9B. In the document reading and stamping processing, image data which is read by the image reading section 14 is stamped and is displayed as a thumbnail image, and an operation in which the image that is read and stamped is stored in the HDD 13, is displayed by a moving image.

For example, being triggered by an input of execution instruction of the document reading and stamping processing through the operation section 11 by a user, the document reading and stamping processing is executed at the image forming apparatus 1 by collaboration of a document reading and stamping program with the CPU, the document reading and storing program being read out from the ROM and being spread in the RAM as needed, in the control section 10.

First of all, required amount of memory is calculated from the size of a document subject to reading (step S301). Then, a required memory is reserved in the image memory 17. (step S302). Subsequently, instruction to read image is sent to the image reading section 14, and the read image is stored in the image memory 17 (step S303).

After execution of step S303, it is determined whether it is a thumbnail display mode or not (step S304). In a case where it is not the thumbnail display mode (step S304; No), it moves on to step S323. In a case where it is the thumbnail display mode (step S304; Yes), amount of memory for thumbnail is calculated from the read image (step S305). After execution of step S305, memory for thumbnail is reserved in the image memory 17 (step S306). Then, the thumbnail is generated in the reserved region (step S307).

Subsequently, the mount paper for thumbnail 41, the thumbnail image 42, and the picture of the HDD 43 are displayed in the display section 12 (step S308). The thumbnail image 42 is displayed in the initial location coordinates of the mount paper for thumbnail 41 (step S309). This step corresponds to FIG. 8A.

Subsequently, the picture of the stamp 44 is displayed (step S310). This step corresponds to FIG. 8B. After execution of step S310, it is determined whether the picture of the stamp 44 is located at the position of the thumbnail image 42 or not (step S311). In a case where it is determined that the picture of the stamp 44 is located at the position of the thumbnail image 42 (step S311; Yes), the stamp is superimposed on the read image data (step S312). In a case where it is determined that the picture of the stamp 44 is not located at the position of the thumbnail image 42 (step S311; No), the display of the picture of the stamp 44 is deleted (step S313). Subsequently, the picture of the stamp 44 is moved to coordinates that are closer to the thumbnail image 42, compared with those before being deleted, and is re-displayed so that designed plane of the picture of the stamp 44 which has the text “Stamp” faces the thumbnail image (step S314). This step corresponds to FIGS. 8C and 8D. After execution of step S314, it goes on to step S311.

After execution of step S312, a thumbnail is re-generated in the reserved region in the image memory 17 (step S315). Subsequently, display of the picture of the stamp 44 is deleted (step S316). Further, display of the thumbnail image 42 is deleted (step S317).

After execution of step S317, the stamped thumbnail image 42 is displayed in the initial location coordinates of the mount paper for thumbnail 41 (step S318). This step corresponds to FIG. 8E. Then, it is determined whether the thumbnail image 42 is located at the position of the picture of the HDD 43 or not (step S319). In a case where the thumbnail image 42 is located at the position of the picture of the HDD 43 (step S319; Yes), the display of the thumbnail image 42 is deleted (step S320). This step corresponds to FIG. 8F. In a case where the thumbnail image 42 is not located at the position of the picture of the HDD 43 (step S319; No), the display of the thumbnail image 42 is deleted (step S321). Subsequently, the thumbnail image 42 is re-displayed in coordinates that are closer to the picture of the HDD 43, compared with those before being deleted (step S322). After execution of step S322, it goes on to step S319.

After execution of step S320, a stamped image is stored in the HDD 13 (step S323). Then, the required memory and the memory for thumbnail are cleared (step S324). After execution of step S324, the document reading and stamping processing is finished.

Next, a display operation of the display section 12, an internal processing operation of the CPU, and an actual equipment operation of the image forming apparatus 1, when the document reading and stamping processing is conducted, will be described with reference to FIGS. 10A through 10C.

First of all, an operation to depress a reading starting button is conducted by a user through the operation section 11 at the image forming apparatus 1 (step S351). This step corresponds to instructing execution of the document reading and stamping processing. When step S351 is executed, the required amount of memory is calculated from the size of the document at the CPU (step S352). Then, the required memory is reserved in the image memory 17 (step S353). After execution of step S353, scanning operation is conducted by the image reading section 14 at the image forming apparatus 1, and the scanned image data is stored in the image memory 17 (step S354).

After execution of step S354, the amount of memory for thumbnail is calculated from the scanned image (step S355). After execution of step S355, a memory for thumbnail is reserved in the image memory 17 (step S356). Then, the thumbnail is generated in the reserved region (step S357).

After execution of step S357, the mount paper for thumbnail 41, the thumbnail image 42, and the picture of the HDD 43 are displayed in the display section 12 (step S358). The thumbnail image 42 is displayed in the initial location coordinates of the mount paper for thumbnail 41 (step S359). After execution of step S359, the picture of the stamp 44 is displayed (step S360). Then, the picture of the stamp 44 is moved closer to the thumbnail image 42, compared with that before being deleted, and is re-displayed so that the designed plane of the picture of the stamp 44 which has the text “Stamp” faces the thumbnail image 42 (step S361). After execution of step S361, display of the picture of the stamp 44 is deleted (step S362). Further, display of the thumbnail image 42 is deleted (step S363).

After execution of step S361, the image data and stamp image are combined (step S364). Then, a thumbnail is re-generated in the reserved region in the image memory 17 (step S365).

After execution of step S365, the stamped thumbnail image 42 is displayed in the initial location coordinates of the mount paper for thumbnail 41 at the display section 12 (step S366). Then, deletion and re-display of the thumbnail image 42 is repeated by shifting the thumbnail image 42 towards the picture of the HDD 43, until the thumbnail image 42 overlaps the picture of the HDD 43 (step S367). After execution of step S367, the display of the thumbnail image 42 is deleted (step S368). Further, displays of the mount paper for thumbnail 41 and the picture of the HDD 43 are deleted (step S369).

After execution of step S368, image data is stored in the HDD 13 at the CPU (step S370). Subsequently, the required memory and the memory for thumbnail are cleared (step S371). After execution of step S371, the operations of each of the sections with respect to the document reading and stamping processing are finished.

As described above, according to the third embodiment, operation relating to the document reading and stamping can be displayed in the display section 12 by the moving image using the thumbnail image 42. Therefore, the image forming apparatus 1 which is capable of allowing a user to confirm that an image reading intended by the user is conducted, can be realized. For example, in a case where the read image has a failure in reading, the user can recognize the failure in the read image when the image is being read. Accordingly, the user can interrupt the reading operation and make the image forming apparatus 1 conduct the intended image reading operation.

Further, the moving image using thumbnail image 42 can indicate that the image read by the image reading section 14 is stored in the HDD 13. Therefore, in a case where the user recognizes a failure in reading when the image is being read, the user can interrupt the reading operation and make the image forming apparatus 1 conduct the intended image reading operation.

The operation of document reading and stamping can be displayed by the moving image using the thumbnail image, on the display section 12. Therefore, it can be confirmed whether top and bottom of the read image is correct or not, when the image is being read.

In addition, in a case where company name, document number, date, and the like are provided as information included in the stamp, these information can be confirmed when the image is being read.

Further, since an operation in which the picture of the stamp 44 is being stamped on the thumbnail image 42 is displayed, the user can intuitively confirm that the stamp is being applied. By referring to the stamped thumbnail image 42, the user can confirm that location setting of the stamp is correct or not.

Here, the description with respect to each of the afore-mentioned embodiments are examples of the image forming apparatus 1 according to the present invention, and the present invention shall not be limited to such.

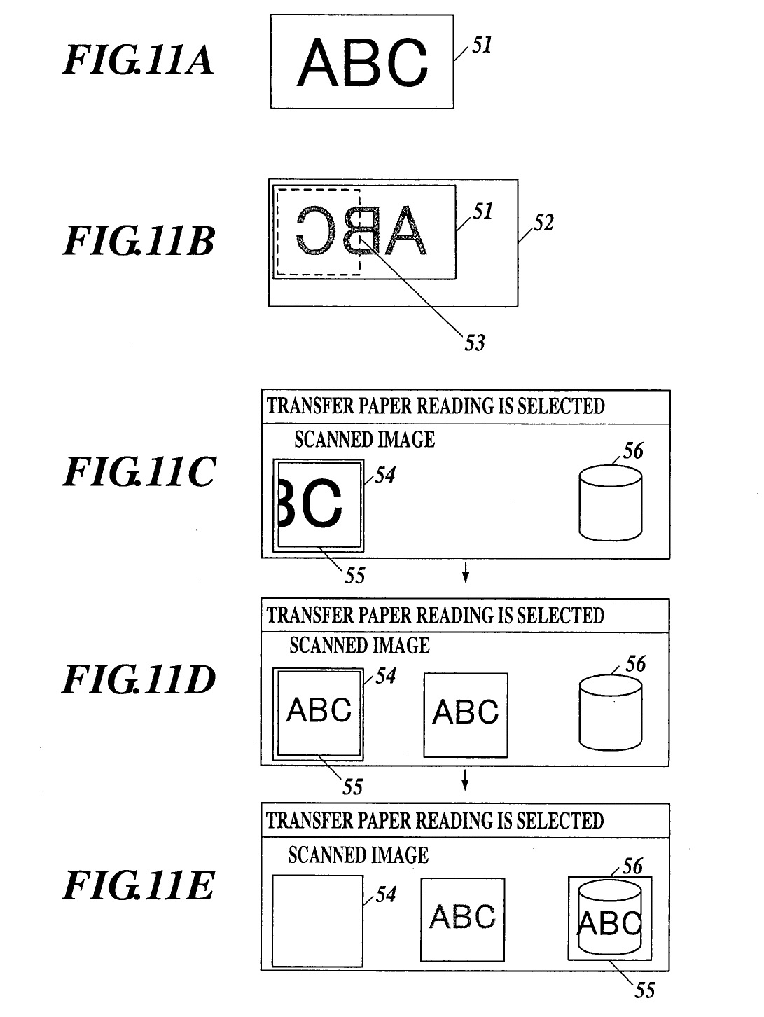

For example, a case where a transfer paper reading is selected as a reading operation of the image reading condition will be described with reference to FIGS. 11A through 11E. Here, in the transfer paper reading, settings are made so that portions of a document that extends off a size of a selected transfer paper is deleted automatically, and reading is conducted only for the portion within the size of the selected transfer paper.

FIG. 11A shows document 51. Here, size of the document 51 is A3, and text of “ABC” is printed on the document. FIG. 11B shows the document 51, platen 52 of the image reading section 14, and transfer paper size 53. Here, A4 size is selected as the transfer paper size 53. A screen which is displayed in the display section 12, in a case where the above-described setting conditions are set and the transfer paper reading is selected, is shown in FIG. 11C. FIG. 11C shows a mount paper for thumbnail 54, a thumbnail image 55, and a picture of the HDD 56. As shown in FIG. 11C, in the thumbnail 55, instead of the document size, only the size of the transfer paper is read. In such case, the user can stop the reading of the document through the operation section 11, and re-set the transfer paper size 53 to A3. In a case where the user re-sets the transfer paper size to A3, as shown in FIG. 11D, the document 51 is read in the thumbnail image 51. Subsequently as shown in FIG. 11E, the thumbnail image 55 moves toward the picture of the HDD 56.

Therefore, the user can recognize that the read image has a failure in reading when the image is being read. In addition, in a case where the user recognizes such failure in reading, the user can interrupt the image reading and make the image forming apparatus 1 conduct the intended image reading.

Further, the present invention may have a structure so that an operation relating to image output is displayed by using a moving image in the display section 12 when conducting image output by the image output section 16. Here, displaying the operation relating to image output by using the moving image means that a moving image, which shows a procedure in which the image data read from the document is printed on the transfer paper, is displayed. For example, showing a procedure in which image data read from one side (both sides) of the document is printed on both sides (one side) of the transfer paper, by the moving image, can be mentioned. Therefore, in a case where the user recognizes an image output failure with respect to the read image when conducting image output, the user can stop the output and make the image forming apparatus conduct an intended image output.

Further, the present invention may have a structure in which a thumbnail image is displayed in the display section 12 in color, in a case where the image read by the image reading section 14 is a color image, and a thumbnail image is displayed in the display section 12 in monochrome, in a case where the image read by the image reading section is a monochrome image. Thus, the user can determine whether the read image is a color image or a monochrome image.

The present invention may also have a structure in which an image density setting condition of the image is displayed when the image is being read and when the image is being output. Thus, the user can discriminate between the density setting condition when the image is being read and the density setting condition when the image is being output.

Alternatively, other precise structures and precise operations of the image forming apparatus 1 according to the afore-described embodiments can be modified so long as it does not deviate the scope of the invention.

According to one aspect of a preferable embodiment of the present invention, there is provided an image forming apparatus comprising:

an image reading section to read image from a document;

a display section to display a reduced image of the image read by the image reading section;

an image output section to output the image read by the image reading section on a transfer paper; and a control section to make the display section display at least a part of a sequential operation which starts from image reading and ends in image output, by a moving image that uses the reduced image.

According to the apparatus, at least a part of the sequential operation which starts from image reading and ends in image output can be displayed in the display section by a moving image using the reduced image. Therefore, the image forming apparatus which is capable of allowing a user to confirm that an image reading intended by the user is conducted, can be realized. For example, in a case where the read image has a failure in reading, the user can recognize the failure in the read image when image reading is conducted. Accordingly, the user can improve the performance of the image forming apparatus by interrupting the reading operation and making the image forming apparatus conduct the intended image reading. Further, the user can recognize failure in output of the read image when image output is conducted. Accordingly, the user can improve the performance of the image forming apparatus by interrupting the output operation and making the image forming apparatus conduct the intended image output.

Preferably, the image forming apparatus further comprises a non-volatile storing section;

wherein the moving image that uses the reduced image includes a moving image showing that the image read by the image reading section is stored in the storing section.

According to the apparatus, the moving image using the reduced image can show that the image read by the image reading section is stored in the storing section. Accordingly, in a case where the user recognizes the failure in the read image when image reading is conducted, the user can improve the performance of the image forming apparatus by interrupting the reading operation and making the image forming apparatus conduct the intended image reading.

Further preferably, the reduced image uses a thumbnail image.

According to the apparatus, the moving image using the reduced image can be displayed as the thumbnail image. Therefore, the performance of the image forming apparatus can be improved with respect to confirming whether top and bottom of the read image is correct or not, when the image is being read.

Still further preferably, the moving image that uses the reduced image includes a moving image includes at least a moving image showing one of both-sides reading of the document, successive page reading of the document, document reading and stamping, and transfer paper reading.

According to the apparatus, the moving image using the reduced image can include at least one of both-sides reading of the document, successive page reading of the document, document reading and stamping, and transfer paper reading.

Preferably, the control section synchronizes an operation to display the both-sides reading of the document by the moving image that uses the reduced image, and an operation of image reading by the image reading section.

According to the apparatus, an operation to display the both-sides reading of the document by the moving image using the reduced image, and an operation of image reading by the image reading section can be synchronized. Accordingly, in a case where the user recognizes the failure in the read image when image reading is conducted, the user can improve the performance of the image forming apparatus by interrupting the reading operation and making the image forming apparatus conduct the intended image reading.

Although various exemplary embodiments have been shown and described, the invention is not limited to the embodiments shown. Therefore, the scope of the invention is intended to be limited solely by the scope of the claims that follow.

What is claimed is:

1. An image forming apparatus comprising:
an image reading section to read image from a document;
a display section to display a reduced image of the image read by the image reading section;
an image output section to output the image read by the image reading section on a transfer paper; and
a control section to make the display section display at least a part of a sequential operation which starts from image reading and ends in image output, by a moving image that uses the reduced image.

2. The image forming apparatus of claim 1, further comprising:
a non-volatile storing section;
wherein the moving image that uses the reduced image includes a moving image showing that the image read by the image reading section is stored in the storing section.

3. The image forming apparatus of claim 1, wherein the reduced image uses a thumbnail image.

4. The image forming apparatus of claim 1, wherein the moving image that uses the reduced image includes at least a moving image showing one of both-sides reading of the document, successive page reading of the document, document reading and stamping, and transfer paper reading.

5. The image forming apparatus of claim 4, wherein the control section synchronizes an operation to display the both-sides reading of the document by the moving image that uses the reduced image, and an operation of image reading by the image reading section.
